(19) United States
(12) Patent Application Publication
(10) Pub. No.: US 2022/0152608 A1
(43) Pub. Date: May 19, 2022

(54) MICROTUBE ASSEMBLY AND MICROTUBE OPERATING SYSTEM THEREOF

(71) Applicant: ARISE BIOTECH CORPORATION, New Taipei (TW)

(72) Inventors: CHUNG-CHE LO, NEW TAIPEI (TW); YI-CHI WANG, NEW TAIPEI (TW)

(21) Appl. No.: 17/168,959

(22) Filed: Feb. 5, 2021

(30) Foreign Application Priority Data
Nov. 19, 2020 (TW) 109140555

(51) Int. Cl. B01L 3/00; G01N 35/00

(52) U.S. Cl. CPC B01L 3/50825; G01N 35/0099; B01L 2300/168; B01L 2300/042; B01L 2300/0832; B01L 2200/0689

(57) ABSTRACT

A microtube assembly includes a column container, a sealing cap and a collecting tube. The column container includes a column body having a first protruding structure, and the one end of the column body has an opening and a first outer thread. The sealing cap has an inner thread matching up with the first outer thread, and the sealing cap is sealed the opening of the column container by the inner thread screwed on the first outer thread of the column body. The collecting tube includes a collecting tube body having a containing space and a matching structure corresponding to the first protruding structure. The containing space is configured for containing the column container. The matching structure leans against the first protruding structure when the sealing cap seals the column container.

### BACKGROUND OF THE INVENTION

### 1. Field of the Invention

The present invention relates to a microtube assembly and a microtube operating system including the microtube assembly, more specifically, relates to a microtube assembly and a microtube operating system including the microtube assembly for automated biological sample preparation, analysis and inspection.

### 2. Description of the Prior Art

Nucleic acid is one of the most basic substances of life. Nucleic acid plays an important decisive role in the growth, inheritance, mutation and other phenomena of organisms. Therefore, the current society continues to research on the structure, function and use of nucleic acid molecules such as DNA and RNA, especially the application of nucleic acid molecules in diagnosis and treatment of diseases and genetic engineering.

The magnetic bead method and the column method are the common methods for extracting and purifying nucleic acids among the extracting and purifying methods. Because the column method has the characteristics of simple operation, high recovery rate, and stable performance, the column method is mostly used to purify nucleic acids with the less sample amount situation. The column method uses a filter membrane as a specific adsorption material for nucleic acids. The filter membrane contains silica, which can adjust the adsorption capacity of nucleic acids through salt concentration and pH value of buffer solutions, and does not adsorb other substances (such as proteins, ions, salts), so the column method can effectively recover and purify the DNA/RNA of the sample.

In the process of purifying nucleic acid by the column method, the biological sample is firstly placed in a column tube of the micro container, and then the micro container is placed in a centrifuge for centrifugation to make the column tube retain nucleic acid and the collecting tube collect waste liquids. However, the micro container includes the collecting tube and the column tube, and the column tube is assembled on the collecting tube in a nested manner. Therefore, when the extraction and purification are completed, the operator cannot directly perform the follow-up operations on the micro container, but must manually extract column tube and the collecting tube. Moreover, the sealing cap is mostly assembled on the column tube by crimping in the existing microtube structure. Therefore, the sealing cap of the microtube is still manually sealed or detached, which not only reduces efficiency but also increases labor costs. In addition, in the existing microtube transfer equipment, the microtube transfer equipment can only move one column tube to the centrifuge for centrifugation at a time. Furthermore, when the extraction and purification are completed, the microtube transfer equipment also can only extract one column tube from the centrifuge at a time, which not only reduces the total extraction volume and extraction efficiency, but also increases the overall extraction time.

Therefore, it is necessary to develop a new micro container and its operating system to solve the problems of the prior art.

### SUMMARY OF THE INVENTION

Therefore, one category of the present invention is to provide a microtube assembly to solve the problems of the prior art.

In one embodiment of the present invention, the microtube assembly includes a column container, a sealing cap and a collecting tube. The column container includes a column body. The column body has a first protruding structure, and the one end of the column body has an opening and a first outer thread. The sealing cap has an inner thread matching up with the first outer thread, and the sealing cap is sealed the opening of the column container by the inner thread screwed on the first outer thread of the column body. The collecting tube includes a collecting tube body. The collecting tube body has a containing space and a matching structure corresponding to the first protruding structure. The containing space is configured for containing the column container. The matching structure leans against the first protruding structure when the column container is rotated.

Wherein, the microtube assembly further includes a base. The base includes a hole configured for containing the collecting tube. The base forming a hollow structure communicated with the hole. The collecting tube further includes a second protruding structure matching up with the hollow structure, and the second protruding structure is disposed in the hollow structure when the collecting tube is contained in the hole.

Wherein, the shapes of the first protruding structure and the second protruding structure are those respectively selected from a bump, a semicircle, a square and a rectangle.

Wherein, the material of the sealing cap is an optically transparent material.

Another one category of the present invention is to provide a microtube operating system to solve the problems of the prior art.

In one embodiment of the present invention, the microtube operating system is configured for sealing or detaching the microtube assembly. The microtube operating system includes a column container, a sealing cap, a collecting tube and an operating component. The column container includes a column body. The column body has a first protruding structure, and the one end of the column body has an opening and a first outer thread. The sealing cap has an inner thread matching up with the first outer thread. The collecting tube includes a collecting tube body. The collecting tube body has a containing space and a matching structure corresponding to the first protruding structure. The containing space is configured for containing the column container. The matching structure leans against the first protruding structure when the column container is rotated. The operating component selectively fixes the sealing cap, and the operating component screws the sealing cap on the end of the column container to seal the opening or detaching the sealing cap from the column container in a rotating manner.

Wherein, the operating component drives the sealing cap and the column container to move after screwing the sealing cap on the end of the column container.

Wherein, the collecting tube includes a second outer thread matching up with the inner thread of the sealing cap. The operating component drives the sealing cap and the collecting tube to move after screwing the sealing cap on the collecting tube.

In one embodiment, the operating component is a robot arm. The robot arm fixes the sealing cap by clamping and rotates the sealing cap to screw the sealing cap on the end of the column container to seal the opening or detaching the sealing cap from the column container.

In one embodiment, the operating component is a revolving rod, and the sealing cap further includes a fixing groove. The revolving rod is engaged with the fixing groove and rotates the sealing cap to screw the sealing cap on the end of the column container to seal the opening or to detach the sealing cap from the column container.

Wherein, the shape of the fixing groove is one selected from a linear shape, a cross shape, a star shape, an explosive shape and polygon.

Wherein, the microtube operating system further includes a base. The base includes a hole configured for containing the collecting tube. The base forming a hollow structure communicated with the hole. The collecting tube further includes a second protruding structure matching up with the hollow structure, and the second protruding structure is disposed in the hollow structure when the collecting tube is contained in the hole.

In summary, the microtube operating system of the present invention automatically drives the column container and the collecting tube to move through the sealing cap with thread automatically. The system not only improves the efficiency but also reduces the labor costs of manual extraction or movement. In addition, the microtube assembly of the present invention leans against and interferes with the protruding structure and groove structure of the column container, the collecting tube and the base, so that the sealing cap can prevent rotation between the column container and the collecting tube when sealing or detaching, thereby improving convenience and installation efficiency.

### BRIEF DESCRIPTION OF THE APPENDED DRAWINGS

FIG. 1 is an exploded diagram illustrating a microtube assembly according to one embodiment of the present invention.

FIG. 2 is a sectional view diagram illustrating the microtube assembly in FIG. 1.

FIG. 3 is an assembly diagram illustrating the microtube assembly in FIG. 1.

FIG. 4A is a schematic diagram illustrating the microtube assembly in FIG. 1 and a base.

FIG. 4B is a schematic diagram illustrating the microtube assembly and the base according to one embodiment of the present invention.

FIG. 5 is a schematic diagram illustrating a microtube operating system according to one embodiment of the present invention.

FIG. 6 is an assembly diagram illustrating the sealing cap and the collecting tube according to one embodiment of the present invention.

FIG. 7 is an exploded diagram illustrating the microtube assembly according to the embodiments of the present invention.

FIG. 8 is a schematic diagram illustrating the microtube operating system according to one embodiment of the present invention.

FIG. 9A and FIG. 9B are schematic diagrams illustrating the sealing cap of the microtube operating system in FIG. 8.

FIG. 10A to FIG. 10D are schematic diagrams illustrating the sealing cap according to embodiments of the present invention.

FIG. 11A and FIG. 11B are schematic diagrams illustrating the operating component according to one embodiment of the present invention.

FIG. 12A and FIG. 12B are schematic diagrams illustrating the operating component according to one embodiment of the present invention.

FIG. 13 is an exploded diagram illustrating the microtube operating system according to one embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments. Moreover, the devices in the figures are only used to express their corresponding positions and are not drawing according to their actual proportion.

In the description of the present invention, it is to be understood that the orientations or positional relationships of the terms “longitudinal, lateral, upper, lower, front, rear, left, right, top, bottom, inner, outer” and the like are based on the orientation or positional relationship shown in the drawings. It is merely for the convenience of the description of the present invention and the description of the present invention, and is not intended to indicate or imply that the device or component referred to has a specific orientation, is constructed and operated in a specific orientation, and therefore cannot be understood as limitations of the invention.

In the description of this specification, descriptions with reference to terms “one embodiment”, “another one embodiment” or “parts of specific embodiments” etc. mean the specific features, structures, materials or characteristics described in conjunction with the embodiment are included in at least one embodiment of the present invention. In this specification, the schematic representations of the above terms do not necessarily refer to the same embodiment. Moreover, the described specific features, structures, materials or characteristics can be combined in any one or more embodiments in a suitable manner.

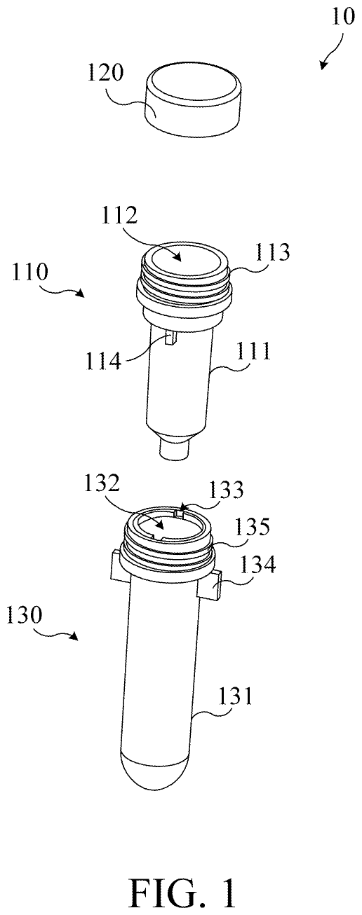

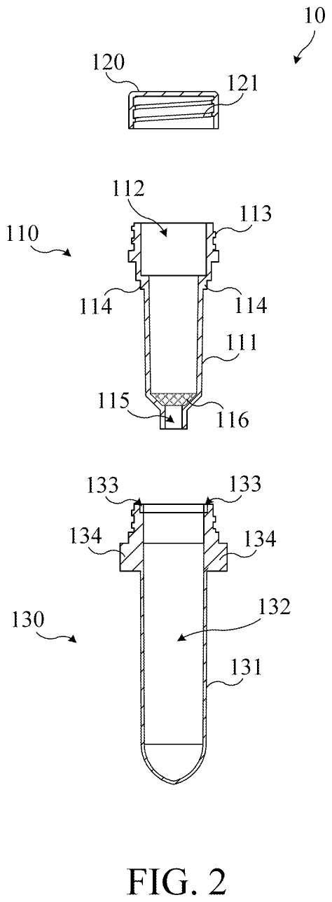

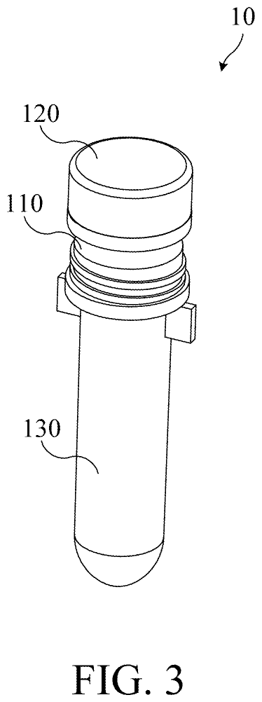

Please refer to FIG. 1, FIG. 2 and FIG. 3. FIG. 1 is an exploded diagram illustrating a microtube assembly 10 according to one embodiment of the present invention. FIG. 2 is a sectional view diagram illustrating the microtube assembly 10 in FIG. E FIG. 3 is an assembly diagram illustrating the microtube 10 assembly in FIG. 1. As shown in FIG. 1 to FIG. 3, in this embodiment, the microtube assembly 10 includes a column container 110, a sealing cap 120 and a collecting tube 130. The column container 110 includes a column body 111, one end of the column body 111 has an opening 112 and a first outer thread 113. The sealing cap 120 has an inner thread 121 matching up with the first outer thread 113, and the sealing cap 120 seals the opening 112 of the column container 110 by the inner thread 121 screwed on the first outer thread 113 of the column body 111. The collecting tube 130 includes a collecting tube body 131, and the collecting tube body 131 has a containing space 132 configured for containing the column container 110.

In practice, the microtube assembly 10 can be applied to a centrifuge to extract and purify nucleic acids or any extraction and purification target. Each of components of the microtube assembly 10 can be transparent or translucent, and the materials of the components can be included plastic, glass or steel, but it is not limit thereto. One end of the collecting tube body 131 is closed, and the other end of that has an opening to form the containing space 132. The column container 110 is contained in the containing space 132. In the nucleic acids extraction process, the column container 110 is configured in the collecting tube 130, and the biological sample is placed in the column container 110. Furthermore, the other side corresponding to the opening 112 of the column container 110 has an opening hole 115, and the column container 110 includes a gasket and a filter membrane 116 configured at the opening hole 115. The end including the filter membrane 116 of the column container 110 is disposed in the containing space 132 of the collecting tube 130, and the sealing cap 120 is configured to seal the opening 112 of the column container 110. That is to say, the column container 110 is located between the sealing cap 120 and the collecting tube 130 (as shown in FIG. 3). The filter membrane 116 of the column container 110 can absorb biological sample that need to be extracted or purified. In the nucleic acids extraction process, the nucleic acids are absorbed on the filter membrane 116 of the column container 110, and the waste liquid and other matters pass through the filter membrane 116 and the opening hole 115 to the collecting tube 130. The inner thread 121 of the sealing cap 120 and the first outer thread 113 of the column container 110 can be directly formed on the sealing cap 120 and the column body 111 respectively. The sealing cap 120 seals the opening 112 of the column container 110 by the inner thread 121 and the first outer thread 113 of the column body 111 in a rotating manner.

In this embodiment, the column body 111 further includes a first protruding structure 114, and the collecting tube body 131 further includes a matching structure 133. As shown in FIG. 2, the matching structure 133 is a grooved structure, and the matching structure 133 is corresponding to the first protruding structure 114. Therefore, the first protruding structure 114 can be inserted into the matching structure 133 from top to bottom direction when the column body 111 is configured in the containing space 132 of the collecting tube body 131. In practice, the first protruding structure 114 and the matching structure 133 can be directly formed on the column body 111 and the collecting tube body 131 respectively. When the inner thread 121 of the sealing cap 120 contacts and screws on the first outer thread 113 of the column container 110, the side wall of the first protruding structure 114 of the column container 110 leans against the matching structure 133 of the collecting tube 130. Therefore, the column container 110 is attached in the collecting tube 130 and cannot be rotated.

Furthermore, the number of the first protruding structure 114 is corresponding to that of the matching structure 133, the size and shape of the first protruding structure 114 are corresponding to those of the matching structure 133, and the position of the first protruding structure 114 is corresponding to that of the matching structure 133. In this embodiment, the numbers of the first protruding structure 114 and the matching structure 133 are two respectively, and the shapes of the first protruding structure 114 and the matching structure 133 are rectangles. It is not limited in practice, the numbers of the first protruding structure 114 and the matching structure 133 can be one or more than three, and the shapes of the first protruding structure 114 and the matching structure 133 can be bumps, semicircles, squares or other shapes that can be matched with each other. Furthermore, the first protruding structure 114 can be located near the opening 112 of the column body 111, and the matching structure 133 can be located at the opening of the collecting tube body 131.

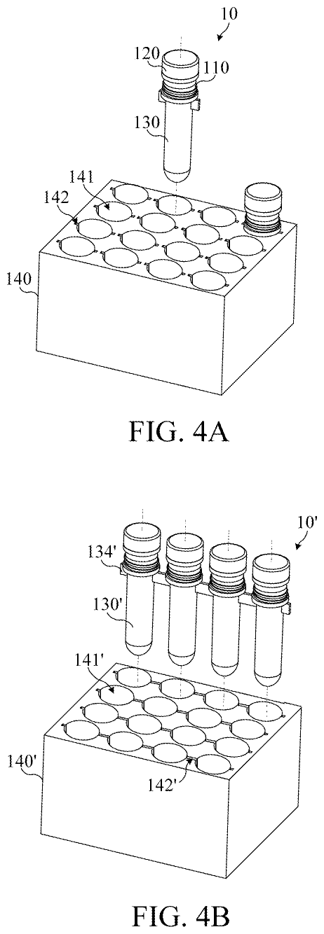

Please refer to FIG. 1 and FIG. 4A. FIG. 4A is a schematic diagram illustrating the microtube assembly 10 in FIG. 1 and a base 140. In this embodiment, the microtube assembly 10 further includes a base 140, and the base 140 includes a hole 141 configured for containing the collecting tube 130. In practice, the base 140 may include a plurality of holes 141, and the holes 141 can be arranged in an array. Furthermore, each of holes 141 of the base 140 includes a hollow structure 142 communicated with the hole 141, and the collecting tube 130 includes a second protruding structure 134. The number and shape of the second protruding structure 134 are corresponding to those of the hollow structure 142. When the sealing cap 120, column container 110 and collecting tube 130 are assembled and configured in the base 140, the second protruding structure 134 is inserted in the hollow structure 142 from top to bottom direction, and the collecting tube 130 is configured in the hole 141 of the base 140. At this time, the side wall of the second protruding structure 134 of the collecting tube 130 leans against the side wall of the hollow structure 142 of the base 140, so that the collecting tube 130 is attached in the base 140 and cannot be rotated. Moreover, the numbers and the sizes of the second protruding structure 134 and the hollow structure 142 are the same as those of the first protruding structure 114 and the matching structure 133, it will not described herein.

In addition to the aforementioned embodiment, the holes of the base may also be other kind of state. Please refer to FIG. 4B. FIG. 4B is a schematic diagram illustrating the microtube assembly 10′ and the base 140′ according to one embodiment of the present invention. As shown in FIG. 4B, the difference between this embodiment and the aforementioned embodiment is that the hollow structures 142′ of two adjacent holes 141′ of the base 140′ are connected to each other. That is to say, the holes 141′ of each row of the base 140′ are connected by the hollow structures 142′. Furthermore, the second protruding structure 134′ of the collecting tube 130′ can also be connected to other second protruding structure 134′ of the collecting tube 130′. In practice, the operator can place multiple microtube assemblies 10′ on the base 140′ at a time for subsequent centrifugation, or extract multiple collecting tubes 130′ from the base 140′ at a time to clean up the waste liquid in the collecting tubes 130′, hence improving operation efficiency and reducing time costs. It should be noted that the numbers of holes 141′ of each row of the base 140′ and the microtube assembly 10′ are not limited to four in FIG. 4B, the numbers of the holes and the microtube assembly can also be two, three or more than four.

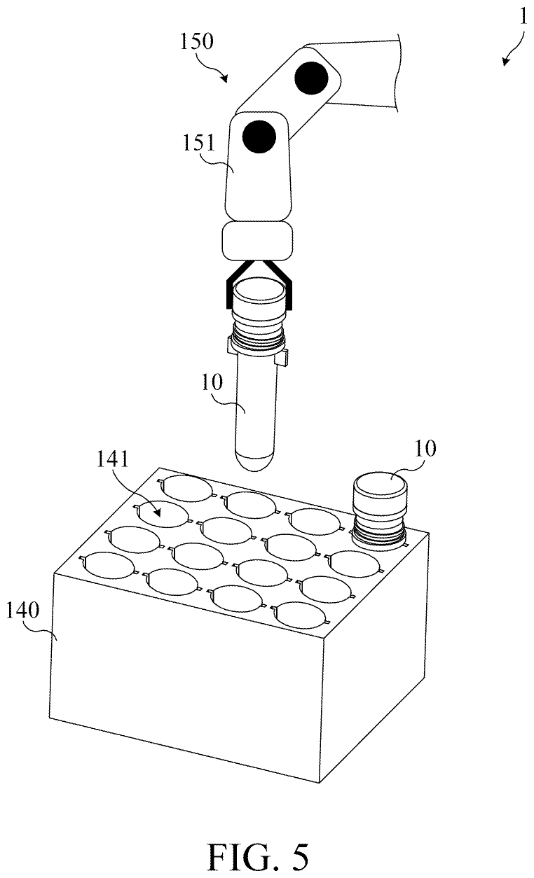

Please refer to FIG. 5. FIG. 5 is a schematic diagram illustrating a microtube operating system 1 according to one embodiment of the present invention. In this embodiment, the microtube operating system 1 also includes an operating component 150 in addition to the column container 110, the sealing cap 120, and the collecting tube 130 of the microtube assembly 10 described above. The operating component 150 is configured to fix the sealing cap 120, and the operating component 150 screws the sealing cap 120 on the end of the column container 110 to seal the opening 112 or detaching the sealing cap 120 from the column container 110 in a rotating manner. In this embodiment, as shown in FIG. 5, the operating component 150 is a robot arm 151. In practice, the robot arm 151 may be multi-axis, rotatable and include a clamping structure (such as a 2-finger or 3-finger gripper). The clamping structure of the robot arm 151 can be designed according to the shape of the sealing cap 120.

Please refer to FIG. 2 and FIG. 5. When the robot arm 151 screws the sealing cap 120 to seal the column container 110, the clamping structure of the robot arm 151 clamps the outer edge of the sealing cap 120, then the robot arm 151 rotates the clamping structure to drive the sealing cap to rotate. When the inner thread 121 of the sealing cap 120 contacts and screws on the first outer thread 113 of the column container 110, the sealing cap 120 can be screwed and assembled on the column container 110 since the column container 110 and the collecting tube 130 cannot be rotated. Therefore, the microtube assembly 10 of the present invention can prevent the rotation of the column container 110 and the collecting tube 130 by engagement between the first protruding structure 114 of the column container 110, the matching structure 133 and the second protruding structure 134 of the collecting tube 130, and the hollow structure 142 of the base 140 to the sealing cap 120 on the column container 110.

Similarly, when the robot arm 151 detaches the sealing cap 120 from the column container 110, the first protruding structure 114 of the column container 110 leans against the matching structure 133 of the collecting tube 130 and the second protruding structure 134 of the collecting tube 130 leans against the hollow structure 142 of the base 140, so that the column container 110 and the collecting tube 130 cannot be rotated. Therefore, the inner thread 121 of the sealing cap 120 can be screwed out of the first outer thread 113 of the column container 110, and then the sealing cap 120 can be detached from the column container 110.

The robot arm 151 can separate the first protruding structure 114 of the column container 110 from the matching structure 133 of the collecting tube 130 from bottom to top direction after the sealing cap 120 is assembled on the column container 110. Then the robot arm 151 can drive the sealing cap 120 and the column container 110 to move at the same time. In practice, when the microtube assembly is completed the nucleic acids extraction process by the centrifuge, the robot arm 151 can clamp the sealing cap 120 and move the sealing cap 120 and the column container 110 containing the nucleic acid to perform subsequent operations. Therefore, the microtube operating system 1 of the present invention can automatically move the column container 110 by the sealing cap 120, which not only improves efficiency and reduces labor costs.

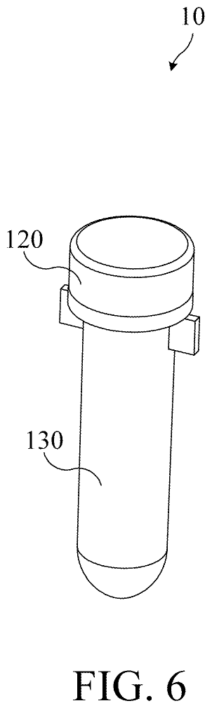

The microtube operating system of the present invention not only can move the column container by sealing cap, but also can move the collecting tube by sealing cap. Please refer to FIG. 1, FIG. 4A and FIG. 6. FIG. 6 is an assembly diagram illustrating the sealing cap 120 and the collecting tube 130 according to one embodiment of the present invention. As shown in FIG. 1, the collecting tube 130 further includes a second outer thread 135 disposed at the opening, and the second outer thread 135 matches up with the inner thread 121 of the sealing cap 120. When the robot arm moves the sealing cap 120 and the column container 110 and detaches the sealing cap 120 from the column container 110, the robot arm further can screw the inner thread 121 of the sealing cap 120 on the second outer thread 135 of the collecting tube 130. When the inner thread 121 of the sealing cap 120 contacts and screws on the second outer thread 135 of the collecting tube 130, the collecting tube 130 and the base 140 cannot rotate mutually since the second protruding structure 134 of the collecting tube 130 is attached in the hollow structure 142 of the base 140. Therefore, the sealing cap 120 can be screwed and assembled on the collecting tube 130. In practice, when the microtube assembly has completed the centrifugation process and the column container is taken from the collecting tube, the robot arm further can take the collecting tube from the centrifuge automatically by the sealing cap, which not only improves efficiency and reduces labor costs.

Furthermore, the material of the sealing cap 120 is an optically transparent material. In practice, the material of the sealing cap 120 can be a transparent polypropylene (PP), polycarbonate (PC), polyvinyl chloride (PVC) or other transparent materials. When the extracted nucleic acid is moved into the collecting tube including reaction reagent for Real-Time polymerase chain reaction (Real-Time PCR), the robot arm can clamp the sealing cap 120 to seal the collecting tube 130, and then move the collecting tube 130 including the nucleic acid and reaction reagent to the measuring position. Then, the laser light or LED light emitted from the detecting equipment can penetrate the sealing cap 120 directly and irradiate the nucleic acid in the collecting tube 130 to measure the number of the reaction products of the nucleic acid. Therefore, the operator can directly perform Real-Time PCR detection without opening the sealing cover 120, which not only improves work efficiency but also reduces time costs.

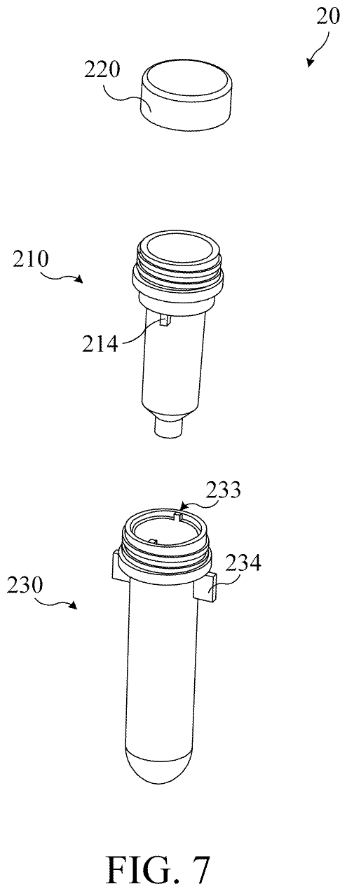

The matching structure of collecting tube not only can be a grooved structure of aforementioned embodiment, the matching structure also can be in other forms. Please refer to FIG. 7. FIG. 7 is an exploded diagram illustrating the microtube assembly 20 according to the embodiments of the present invention. As shown in FIG. 7, the difference between this embodiment and the aforementioned embodiment is that the matching structure 233 of the collecting tube 230 is a bulged structure. The matching structure 233 of the collecting tube 230 leans against the first protruding structure 214 of the column container 210 when the column container is rotated. In practice, when the robot arm screws and seals the sealing cap 220 to the column container 210, the sealing cap 220 drives the column container 210 to move. Then, the first protruding structure 214 of the column container 210 contacts the matching structure 233 of the collecting tube 230 when the column container 210 moves for a distance. Furthermore, when the robot arm continuous rotates the sealing cap 220, the matching structure 233 of the collecting tube 230 will lean against the first protruding structure 214 of the column container 210, so that the column container 210 cannot be rotated. At this time, the second protruding structure 234 of the collecting tube 230 is also attached in the hollow structure of the base, so that the collecting tube 230 cannot be rotated. Therefore, the sealing cap 220 can be sealed on the column container 210.

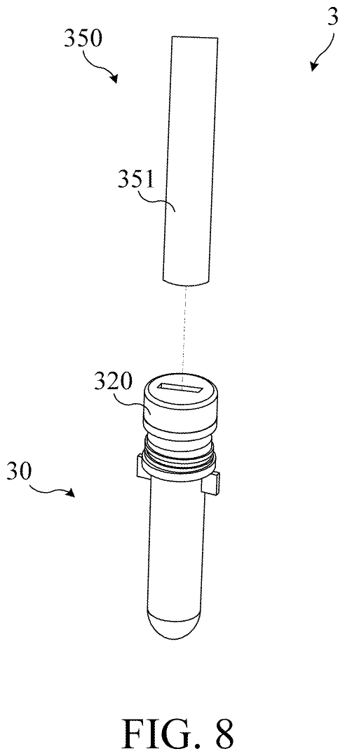

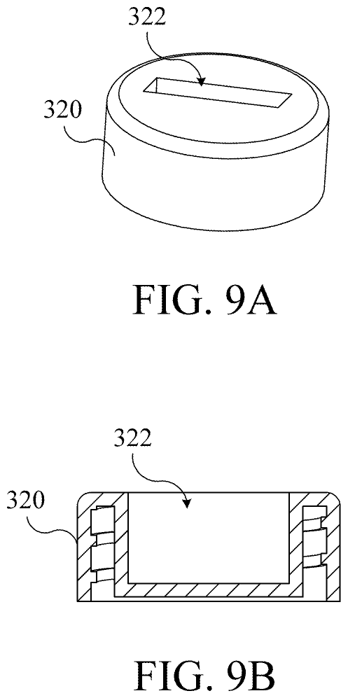

In addition to the robot arm, the operating component can also be in other forms. Please refer to FIG. 8, FIG. 9A and FIG. 9B. FIG. 8 is a schematic diagram illustrating the microtube operating system 3 according to one embodiment of the present invention. FIG. 9A and FIG. 9B are schematic diagrams illustrating the sealing cap 320 of the microtube operating system 3 in FIG. 8. In this embodiment, the operating component 350 is a revolving rod 351, and the sealing cap 320 has a fixing groove 322. In practice, the operating component 350 can be configured on a moving device. The revolving rod 351 can be driven to rotate in combination with motor, screw rod, gear etc., and can be configured on a sliding rail to move in multiple directions. The fixing groove 322 of the sealing cap 320 is disposed on the other side relative to the opening of the sealing cap 320. That is to say, the fixing groove 322 is located on the top side of the microtube assembly 30 when the microtube assembly 30 is assembled. Furthermore, the shape of the end of the revolving rod 351 is corresponding to that of the fixing groove 322. In this embodiment, the shapes of the fixing groove 322 and the end of the revolving rod 351 are linear shape. In practice, when the revolving rod 351 moves and attach to the fixing groove 322 of the sealing cap 320, the end of the revolving rod 351 and the fixing groove 322 of the sealing cap 320 are tightly connected. Therefore, the sealing cap 320 can be fixed on the revolving rod 351. Furthermore, when the revolving rod 351 rotates in the direction of the axis, the revolving rod 351 drive the sealing cap 320 to rotate, thereby sealing the sealing cap 320 to the opening of the column container 310 or detaching the sealing cap 320 from the column container 310. It should be noted that the functions of the column container 310 and the collecting tube 330 are the same as the corresponding components of the aforementioned embodiments, and it will not described herein.

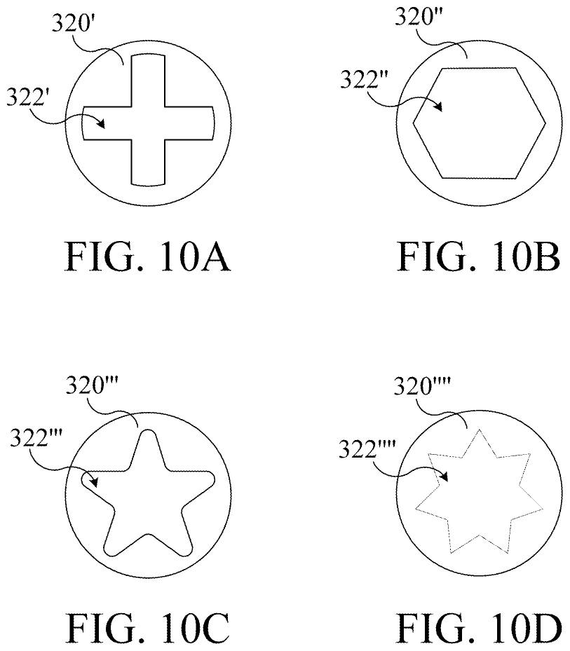

Moreover, the shape of the fixing groove is not limited to linear shape, the shape of the fixing groove can also be other types. Please refer to FIG. 10A to FIG. 10D. FIG. 10A to FIG. 10D are schematic diagrams illustrating the sealing cap 320′, 320″, 320′″ and 320″″ according to embodiments of the present invention. In practice, the fixing groove can also be a cross-shaped fixing groove 322′, a hexagonal fixing groove 322″, a star-shaped fixing groove 322′″, a explosive-shaped fixing groove 322′, or other polygon-shaped fixing groove.

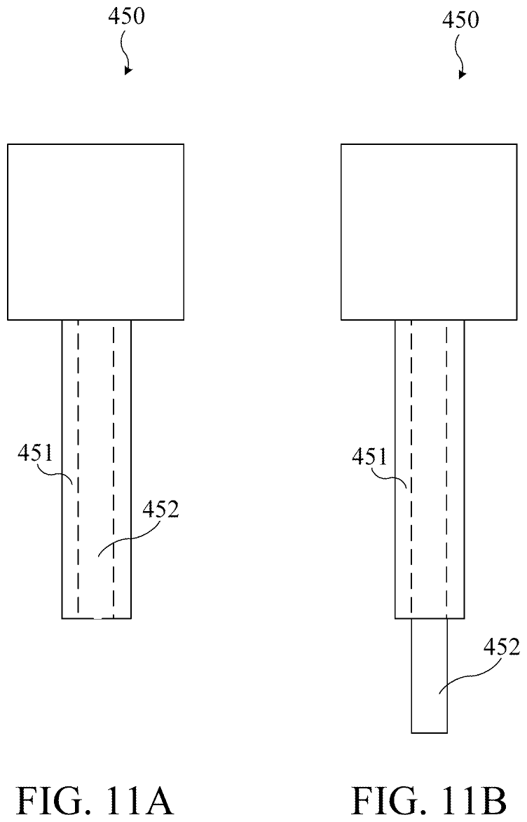

The operating component not only includes the revolving rod that can be engaged with the sealing cap for rotation or movement, but also includes a mechanism for separating the rotating rod from the sealing cap. Please refer to FIG. 11A and FIG. 11B. FIG. 11A and FIG. 11B are schematic diagrams illustrating the operating component 450 according to one embodiment of the present invention. In this embodiment, as shown in FIG. 11A, the operating component 450 includes a revolving rod 451 and a telescopic rod 452, and the revolving rod 451 is sleeved outside of the telescopic rod 452. The telescopic rod 452 can be extended from the revolving rod 451 by pushing (as shown in FIG. 11B). Furthermore, the area of the telescopic rod 452 is smaller than that of the fixing groove of the sealing cap. The telescopic rod 452 extends from the axis of the revolving rod 451 and moves away from the fixing groove after the revolving rod 451 is attached in the fixing groove of the sealing cap, so that the revolving rod 451 is separated from the sealing cap. In practice, when the operating component 450 has completed the transfer operation and needs to be removed from the sealing cap, the telescopic rod 452 can extend from revolving rod 451 and press against the fixing groove of the sealing cap by a pushing force, and the revolving rod 451 move in opposite directions of the sealing cap. Therefore, the revolving rod 451 is separated from the sealing cap.

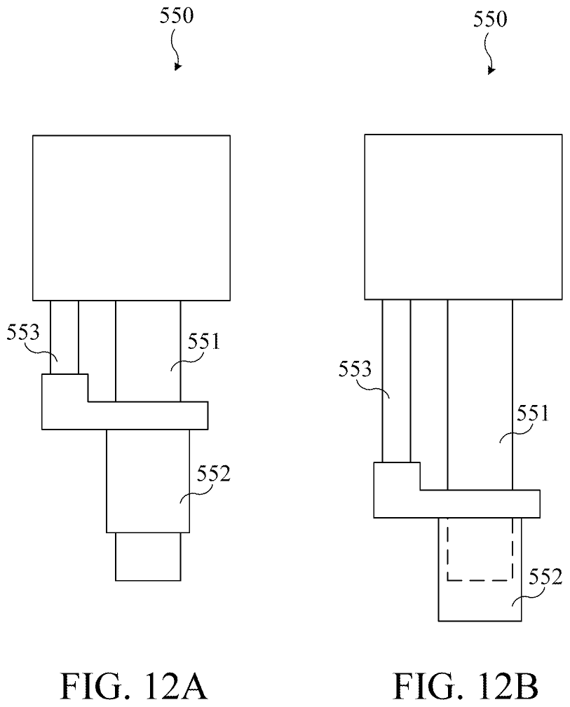

In one embodiment, please refer to FIG. 12A and FIG. 12B. FIG. 12A and FIG. 12B are schematic diagrams illustrating the operating component 550 according to one embodiment of the present invention. As shown in FIG. 12A, the operating component 550 includes a revolving rod 551 and a socket 552, and the socket 552 is sleeved outside of the revolving rod 551. The socket 552 further can be connected to a telescopic and moving component 553, and the telescopic and moving component 553 pushes the socket 552 to extend from the revolving rod 551 (as shown in FIG. 12B). Furthermore, the area of the socket 552 can be greater than that of the top surface of the sealing cap. The socket 552 extends from the axis of the revolving rod 551 and moves away from the fixing groove after the revolving rod 551 is attached in the fixing groove of the sealing cap, so that the revolving rod 551 is separated from the sealing cap. In practice, when the operating component 550 has completed the transfer operation and needs to be removed from the sealing cap, the socket 552 can extend from revolving rod 551 and press against the top side of the sealing cap by a pushing force, and the revolving rod 551 move in opposite directions of the sealing cap. Therefore, the revolving rod 551 is separated from the sealing cap.

In another one embodiment, the operating component includes a revolving rod and a clamping cylinder configured on the end of the revolving rod. The clamping cylinder is clamped on the outer surface of the sealing cap, and then the revolving rod rotates in axis direction. At this time, the revolving rod drives the clamping cylinder to rotate, and the clamping cylinder drives the sealing cover to rotate, thereby sealing the sealing cap to the opening of the column container or detach from the column container.

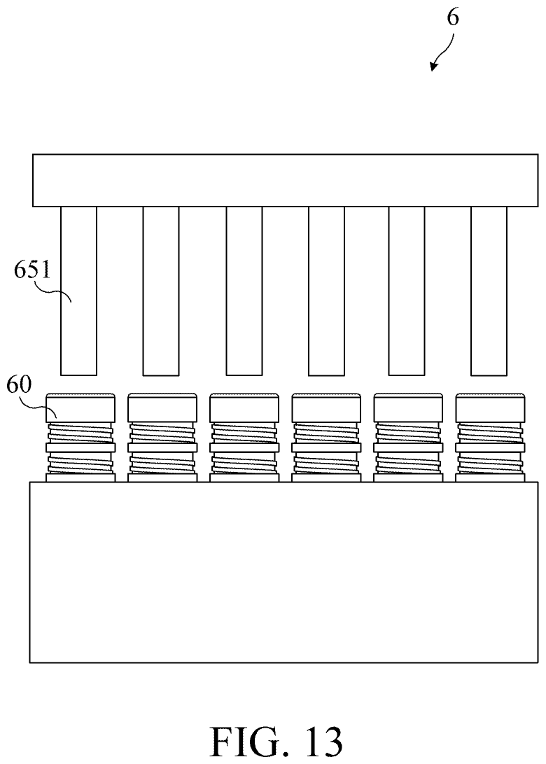

Please refer to FIG. 13. FIG. 13 is an exploded diagram illustrating the microtube operating system 6 according to one embodiment of the present invention. In this embodiment, the microtube operating system 6 includes a plurality of revolving rods 651, and the revolving rods 651 are arranged in a raw. Furthermore, the revolving rods 651 can be configured on one moving device, and the revolving rods 651 can be rotated simultaneously or separately. Therefore, the microtube operating system 6 can seal, disassemble and move the microtube assembly 60 simultaneously, thereby improving efficiency and reducing time cost. It should be noted that the numbers of the revolving rods of the microtube operating system are not limited to six in the figure, and the number of the revolving rod can be one, two, three, four, five or more than six.

In conclusion, the microtube operating system of the present invention automatically drives the column container and the collecting tube to move through the sealing cap with thread automatically. The system not only improves the efficiency but also reduces the labor costs of manual extraction or movement. In addition, the microtube assembly of the present invention leans against and interferes with the protruding structure and groove structure of the column container, the collecting tube and the base, so that the sealing cap can prevent rotation between the column container and the collecting tube when sealing or detaching, thereby improving convenience and installation efficiency.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A microtube assembly, comprising:
a column container, comprising a column body, the column body having a first protruding structure, and one end of the column body having an opening and a first outer thread;
a sealing cap, having an inner thread matching up with the first outer thread, and the sealing cap sealing the opening of the column container by the inner thread screwed on the first outer thread of the column body; and
a collecting tube, comprising a collecting tube body, the collecting tube body having a containing space and a matching structure corresponding to the first protruding structure, the containing space being configured for containing the column container, wherein the matching structure leans against the first protruding structure when the sealing cap seals the column container to prevent rotation between the column container and the collecting tube.

2. The microtube assembly of claim 1, further comprising a base, the base comprising a hole configured for containing the collecting tube, the base forming a hollow structure communicated with the hole, wherein the collecting tube further comprises a second protruding structure matching up with the hollow structure, the second protruding structure is configured in the hollow structure when the collecting tube is contained in the hole.

3. The microtube assembly of claim 2, wherein the shapes of the first protruding structure and the second protruding structure are those respectively selected from a bump, a semicircle, a square and a rectangle.

4. The microtube assembly of claim 1, wherein the material of the sealing cap is an optically transparent material.

5. A microtube operating system for sealing or detaching a microtube assembly, the microtube operating system comprising:
a column container, comprising a column body, the column body having a first protruding structure, and one end of the column body having an opening and a first outer thread;
a sealing cap, having an inner thread matching up with the first outer thread;
a collecting tube, comprising a collecting tube body, the collecting tube body having a containing space and a matching structure corresponding to the first protruding structure, the containing space being configured for containing the column container, wherein the matching structure leans against the first protruding structure when the sealing cap seals the column container to prevent rotation between the column container and the collecting tube; and
an operating component, configured for selectively fixing the sealing cap, the operating component screwing the sealing cap on the end of the column container to seal the opening or detaching the sealing cap from the column container in a rotating manner.

6. The microtube operating system of claim 5, wherein the operating component drives the sealing cap and the column container to move after screwing the sealing cap on the end of the column container.

7. The microtube operating system of claim 5, wherein the collecting tube comprises a second outer thread matching up with the inner thread of the sealing cap, the operating component drives the sealing cap and the collecting tube to move after screwing the sealing cap on the collecting tube.

8. The microtube operating system of claim 5, wherein the operating component is a robot arm, the robot arm fixes the sealing cap by clamping and rotates the sealing cap to screw the sealing cap on the end of the column container to seal the opening or detaching the sealing cap from the column container.

9. The microtube operating system of claim 5, wherein the operating component is a revolving rod, and the sealing cap further comprises a fixing groove, the revolving rod is engaged with the fixing groove and rotates the sealing cap to screw the sealing cap on the end of the column container to seal the opening or detaching the sealing cap from the column container.

10. The microtube operating system of claim 9, wherein the shape of the fixing groove is one selected from a linear shape, a cross shape, a star shape, an explosive shape and polygon.

11. The microtube operating system of claim 5, further comprising a base, the base comprising a hole configured for containing the collecting tube, the base forming a hollow structure communicated with the hole, wherein the collecting tube further comprises a second protruding structure matching up with the hollow structure, the second protruding structure is configured in the hollow structure when the collecting tube is contained in the hole.

12. The microtube operating system of claim 11, wherein the shapes of the first protruding structure and the second protruding structure are those respectively selected from a bump, a semicircle, a square and a rectangle.

13. The microtube operating system of claim 5, wherein the material of the sealing cap is an optically transparent material.
